(19) United States
(12) Patent Application Publication
(10) Pub. No.: US 2025/0096406 A1
(43) Pub. Date: Mar. 20, 2025

(54) BATTERY MODULE

(71) Applicant: Caterpillar Inc., Peoria, IL (US)

(72) Inventors: Peitong Jin, Dunlap, IL (US); Jinhui Irvin Sun, Dunlap, IL (US)

(73) Assignee: Caterpillar Inc., Peoria, IL (US)

(21) Appl. No.: 18/468,795

(22) Filed: Sep. 18, 2023

(51) Int. Cl. H01M 50/383; H01M 50/204; H01M 50/682

(52) U.S. Cl. CPC H01M 50/383; H01M 50/204; H01M 50/682; H01M 2200/20

(57) ABSTRACT

A battery module includes a housing including a first end plate defining a vent opening, a second end plate, a first side plate coupled to the first end plate and the second end plate, and a second side plate coupled to the first end plate and the second end plate. The battery module also includes a plurality of battery cells secured within the housing. The battery module further includes at least one first flame retarding device disposed within the battery module, coupled to the housing proximate to the vent opening and holds a flame retarding agent therein. The at least one first flame retarding device ruptures and releases the flame retarding agent to neutralize gases ejected from one or more of the plurality of battery cells during a thermal event of one or more of the plurality of battery cells.

### TECHNICAL FIELD

The present disclosure relates to a battery module and a method of neutralizing gases ejected from the battery module.

### BACKGROUND

Battery modules are used in a variety of applications as a means of power supply. For example, battery modules are being increasingly implemented in passenger vehicles, construction machines, and the like, to provide power supply.

Generally, battery modules may include high-energy density volatile battery cells to store electrical power and distribute the stored electrical power. However, in some instances, one or more battery cells may experience a thermal event, such as, overheating, fire propagation, or thermal runaway. Such thermal events of one or more battery cells may result in release of gases that may damage adjacent battery cells in the battery module and/or components disposed adjacent to the battery modules. For example, as multiple battery modules are coupled to each other to form a battery cell stack, thermal events of one or more battery cells associated with one of the battery modules may have an undesirable impact on other battery modules in the battery cell stack.

U.S. Publication Application Number 2021/0074979, hereinafter referred to as '979 reference, describes an energy storage module that includes: a cover member accommodating a plurality of battery cells in an internal receiving space, the battery cells being arranged in a first direction, each of the battery cells including a vent; a top plate coupled to a top of the cover member and including a duct corresponding to the vent of each of the battery cells; a top cover coupled to a top of the top plate and having a discharge opening corresponding to the duct; and an extinguisher sheet between the top cover and the top plate, the extinguisher sheet being configured to emit a fire extinguishing agent at a reference temperature.

However, the '979 reference does not describe use of the extinguisher sheets proximate to a vent opening of the energy storage module in order to neutralize gases being ejected from the battery cells during thermal events. Further, during thermal events, various gases or particles, such as, carbon, nickel, etc. may be emitted from the battery cells. The '979 reference also does not disclose any means to trap such particles, to prevent an exit of such particles into the atmosphere. Moreover, the '979 reference does not describe any means to guide the flow of gases towards the vent opening of the energy storage module. Additionally, the '979 reference does not describe any means to minimize/contain thermal events once the gases released from the battery cells exit the energy storage module.

### SUMMARY OF THE DISCLOSURE

In an aspect of the present disclosure, a battery module is provided. The battery module includes a housing. The housing includes a first end plate defining a first end of the battery module. The first end plate defines a vent opening. The housing also includes a second end plate defining a second end of the battery module opposite the first end. The housing further includes a first side plate coupled to the first end plate and the second end plate. The housing includes a second side plate opposite the first side plate. The second side plate is coupled to the first end plate and the second end plate. The battery module also includes a plurality of battery cells secured within the housing between the first end plate, the second end plate, the first side plate, and the second side plate. The battery module further includes at least one first flame retarding device disposed within the battery module. The at least one first flame retarding device is coupled to the housing proximate to the vent opening of the first end plate. The at least one first flame retarding device holds a flame retarding agent therein. The at least one first flame retarding device ruptures and releases the flame retarding agent to neutralize gases ejected from one or more of the plurality of battery cells during a thermal event of one or more of the plurality of battery cells.

In another aspect of the present disclosure, a method of neutralizing gases ejected from a battery module is provided. The method includes disposing at least one first flame retarding device within the battery module. The at least one first flame retarding device holds a flame retarding agent therein. The battery module includes a housing including a first end plate defining a vent opening, a second end plate, a first side plate coupled to the first end plate and the second end plate, and a second side plate coupled to the first end plate and the second end plate. The battery module includes a plurality of battery cells secured within the housing between the first end plate, the second end plate, the first side plate, and the second side plate. The at least one first flame retarding device is coupled to the housing proximate to the vent opening of the first end plate. The method also includes rupturing the at least one first flame retarding device during a thermal event of one or more of the plurality of battery cells. The method further includes releasing the flame retarding agent from the at least one first flame retarding device to neutralize gases ejected from one or more of the plurality of battery cells during the thermal event of one or more of the plurality of battery cells.

Other features and aspects of this disclosure will be apparent from the following description and the accompanying drawings.

### BRIEF DESCRIPTION OF THE DRAWINGS

FIG. 1 is a schematic perspective view of a battery module, according to an example of the present disclosure;

FIG. 2 is an exploded view of a portion of the battery module of FIG. 1, according to an example of the present disclosure;

FIGS. 3A and 3B are schematic views of first flame retarding devices associated with the battery module of FIG. 1, according to various examples of the present disclosure;

FIG. 4 is a schematic perspective view illustrating multiple battery cells of the battery module of FIG. 1, according to an example of the present disclosure;

FIG. 5 is a cross-sectional view of a single battery cell associated with the battery module of FIG. 1;

FIG. 6 is a schematic perspective view of a battery system including the battery module of FIG. 1, according to an example of the present disclosure; and

FIG. 7 is a flowchart for a method of neutralizing gases ejected from the battery module of FIG. 1, according to an example of the present disclosure.

### DETAILED DESCRIPTION

Wherever possible, the same reference numbers will be used throughout the drawings to refer to the same or like parts.

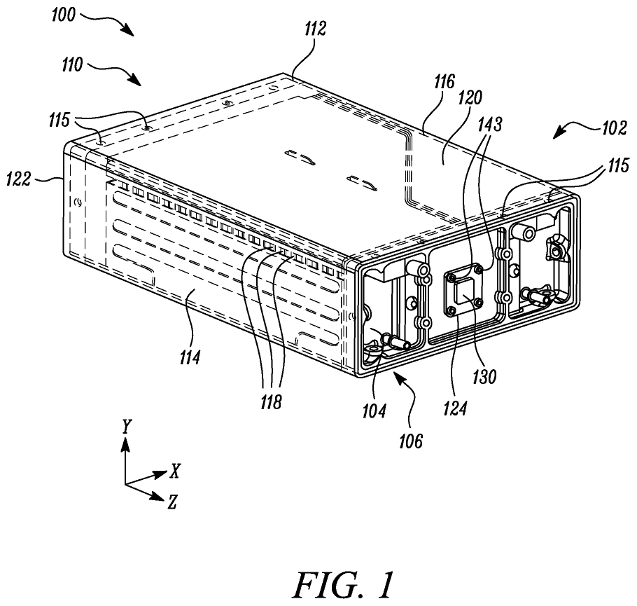

Referring to FIG. 1, a schematic perspective view of an exemplary battery module 100 is illustrated. In an example, the battery module 100 supplies electrical power to a machine. The machine may include a moving machine or a stationary machine. In some examples, the machine may be a work/construction machine, for example.

The battery module 100 includes a housing 102. In some examples, the battery module 100, or components thereof, such as the housing 102, may be made of aluminum, composites, plastics, and/or any other suitable material. In some examples, multiple battery modules (similar to the battery module 100), which include similar housings, may be electrically coupled to one another to provide a desired power output and voltage output. As such, although one battery module 100 is shown in FIG. 1, multiple such battery modules may be electrically coupled together in a stacked relationship.

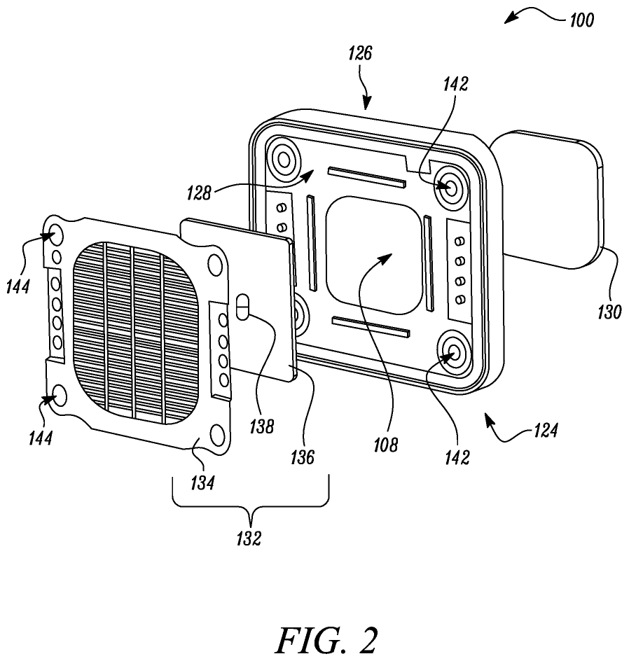

The housing 102 includes a first end plate 104 defining a first end 106 of the battery module 100. The first end plate 104 defines a vent opening 108 (shown in FIG. 2). The first end plate 104 extends along an X-direction. The housing 102 also includes a second end plate 112. The second end plate 112 defines a second end 110 of the battery module 100 opposite to the first end 106. The second end plate 112 extends along the X-direction. The second end plate 112 is spaced apart from the first end plate 104 in a Z-direction.

The housing 102 further includes a first side plate 114 coupled to the first end plate 104 and the second end plate 112. Specifically, the first side plate 114 couples to the first end plate 104 at the first end 106, and the first side plate 114 couples to the second end plate 112 at the second end 110. The housing 102 includes a second side plate 116 opposite the first side plate 114. The second side plate 116 is coupled to the first end plate 104 and the second end plate 112. Specifically, the second side plate 116 couples to the first end plate 104 at the first end 106, and the second side plate 116 couples to the second end plate 112 at the second end 110. The first end plate 104, the second end plate 112, the first side plate 114, and the second side plate 116 together form the housing 102 and form a sealed structure.

Each of the first side plate 114 and the second side plate 116 extend along the Z-direction and are disposed parallel to each other. It should be noted that the first side plate 114 and the second side plate 116 are spaced apart from one another (e.g., in the X-direction). In some examples, each of the first side plate 114 and the second side plate 116 may be coupled to the first end plate 104 and the second end plate 112 by welding to form a box-shaped structure.

The battery module 100 includes a cover 122 extending between the first end plate 104 and the second end plate 112. The cover 122 surrounds the first side plate 114 and the second side plate 116 of the housing 102. The cover 122 is coupled to the first end plate 104 and the second end plate 112 via one or more fastening means 115. In some examples, the fastening means 115 may include a bolt, a screw, a pin, a rivet, or any other fastening means. The first end plate 104, the second end plate 112, and the cover 122 are coupled to each other and define an interior cavity of the battery module 100. In some cases, the cover 122 forms a substantially fluid-tight seal with the first end plate 104 and the second end plate 112.

The battery module 100 also includes a number of battery cells 118 secured within the housing 102 between the first end plate 104, the second end plate 112, the first side plate 114, and the second side plate 116. The cover 122 surrounds the battery cells 118. The battery cells 118 are disposed within the interior cavity of the battery module 100 defined by the first end plate 104, the second end plate 112, and the cover 122. The first side plate 114 and the second side plate 116 along with the first end plate 104 and the second end plate 112 assist in retaining the battery cells 118 within the battery module 100 to prevent movement, shifting, and the like, during use.

The one or more battery cells 118 may incorporate, for example, a lithium-ion battery technology to store electrical power and distribute the stored electrical power at a desired battery module voltage and a desired battery module amperage. It should be noted that the power distribution and power storage characteristics of the battery module 100 may be defined at least in part on the configurations of the one or more battery cells 118 included in the battery module 100. In other examples, the battery module 100 may embody any other type of battery technology such as a lead-acid battery technology, nickel metal hydride (NiMH) battery technology, and the like that converts chemical energy directly to electrical energy by utilizing a difference in bond energies of the compounds utilized in the construction of the battery module 100. Further, the battery cells 118 may include any capacity, voltage, energy, etc.

The battery module 100 further includes a top plate 120. The top plate 120 covers at least a portion of the battery cells 118 that reside within the housing 102. Specifically, the top plate 120 is disposed vertically over or above (e.g., in a Y-direction) the battery cells 118. The top plate 120 may define a flow path (not shown herein) that may assist in channeling gases released from one or more of the number of battery cells 118 towards the vent opening 108 in the first end plate 104. For example, the flow path may direct gases released from one or more of the battery cells 118 towards the vent opening 108 in the first end plate 104 in case of a thermal event of the one or more battery cells 118.

FIG. 2 is an exploded view of a portion of the battery module 100 of FIG. 1. Only some of the components of the battery module 100 are illustrated and described in FIG. 2 for explanatory purposes. The first end plate 104 (see FIG. 1) includes a base plate 124. The base plate 124 defines a first side 126 and a second side 128 opposite the first side 126. The first side 126 faces the battery cells 118 (see FIG. 1), whereas the second side 128 faces the environment. The vent opening 108 of the first end plate 104 is defined by the base plate 124. As shown herein, the vent opening 108 is square in shape. Alternatively, the vent opening 108 may be rectangular in shape, circular in shape, and the like.

Further, in the illustrated example of FIG. 2, the base plate 124 has a square shape. In other examples, the base plate 124 may have a rectangular shape, a circular shape, or any other shape, based on application attributes. The first end plate 104 defines a through-aperture (not shown) that at least partially receives the base plate 124 therein. Further, the through-aperture in the first end plate 104 is sized and shaped so as to accommodate the base plate 124 therein. The base plate 124 includes one or more first openings 142. Specifically, the base plate 124 includes four first openings 142 herein. The base plate 124 may be made of any composite, plastic, rubber, and/or combinations thereof.

The battery module 100 also includes a pressure relief cap 130 coupled to the base plate 124 at the first side 126 of the base plate 124. The pressure relief cap 130 is embodied as a burst disc that dislodges from the base plate 124 when a pressure within the battery module 100 exceeds a predefined pressure value. The pressure relief cap 130 may be impermeable to gases and/or other fluids so as to enclose or seal the battery module 100. The pressure relief cap 130 may be made from any composites, plastic, rubber, and/or combinations thereof. The pressure relief cap 130 is in alignment with the vent opening 108 and closes the vent opening 108 to isolate the interior cavity from the environment. A shape of the pressure relief cap 130 is same as a shape of the vent opening 108. The pressure relief cap 130 has a square shape herein. Alternatively, the pressure relief cap 130 may have a rectangular shape, a circular shape, and the like. The base plate 124 and the pressure relief cap 130 may include any design and dimensions different from what is shown herein, as per application requirements.

The housing 102 further includes a filter assembly 132 coupled to the base plate 124 at the second side 128 of the base plate 124. The filter assembly 132 includes a mesh screen 134 and a filter membrane 136. The filter membrane 136 is disposed between the mesh screen 134 and the base plate 124. The mesh screen 134 includes one or more second openings 144. Specifically, the mesh screen 134 includes four second openings 144 herein. Each second opening 144 aligns with a corresponding first opening 142 in the base plate 124 and an opening (not shown) in the first end plate 104 to receive a corresponding fastener 143 (shown in FIG. 1). The battery module 100 includes four fasteners 143 that couple the base plate 124, the mesh screen 134, and the first end plate 104 with each other. In some examples, the fastener 143 may be a bolt, a screw, a rivet, and the like. The filter membrane 136 of the filter assembly 132 may trap any particles released from one or more battery cells 118 during thermal events. Thus, the filter membrane 136 may prevent emission of such particles into the environment. The particles may include, for example, carbon, nickel, or any other active particles released from the battery cells 118.

Further, the filter assembly 132 may provide a passage to the gases ejected from one or more battery cells 118 during thermal events, such as, during a thermal runaway event during which gases may be emitted from the one or more battery cells 118.

The battery module 100 further includes one or more first flame retarding devices 138 disposed within the battery module 100. The one or more first flame retarding devices 138 are coupled to the housing 102 proximate to the vent opening 108 of the first end plate 104. In the illustrated example of FIG. 2, the one or more first flame retarding devices 138 are coupled to the filter membrane 136. Specifically, the first flame retarding device 138 may be disposed on the filter membrane 136 such that the first flame retarding device 138 is in alignment with the vent opening 108. Alternatively, the first flame retarding device 138 may be coupled to the first end plate 104 or the mesh screen 134, instead of the filter membrane 136.

In the illustrated example of FIG. 2, the single first flame retarding device 138 is illustrated. However, the battery module 100 may include multiple first flame retarding devices 138 based on application attributes. In some examples, a total number of the first flame retarding devices 138 may be based on factors, such as, a number of the battery cells 118, a size of the housing 102 (see FIG. 1), and the like. Further, the first flame retarding device 138 may be coupled to the filter membrane 136 via an adhesive (not shown). The adhesive may include, for example, a double-sided adhesive tape or an adhesive layer. Alternatively, any other coupling means may be used to couple the first flame retarding device 138 with the filter membrane 136. It should be noted that a size of the first flame retarding device 138 is exemplary in nature, and the size of the first flame retarding device 138 may vary, for example, based on a size of the battery module 100.

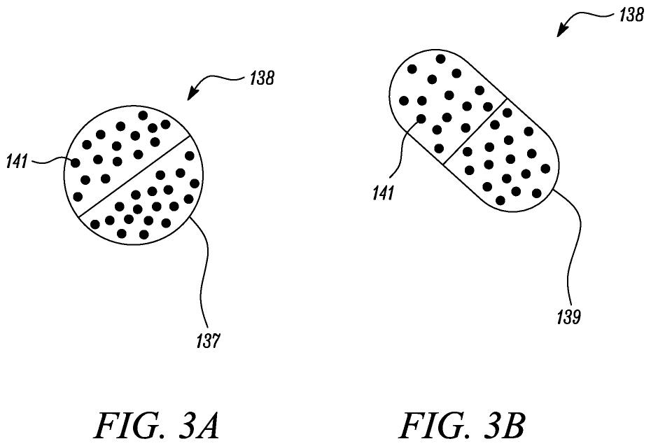

The first flame retarding device 138 holds a flame retarding agent 141 (shown in FIGS. 3A and 3B) therein. In some examples, the flame retarding agent 141 may include a halogen agent, a carbonate agent, a polyolefin agent, and/or a combination thereof. It should be noted that the present disclosure is not limited to a composition of the flame retarding agent 141.

The first flame retarding device 138 ruptures and releases the flame retarding agent 141 to neutralize gases ejected from one or more of the number of battery cells 118 during the thermal event of one or more of the number of battery cells 118. The thermal event may include, for example, an overheating event, a runaway event, or a fire propagation event. Particularly, the first flame retarding device 138 ruptures based on at an internal pressure within the battery module 100 exceeding a pressure threshold and/or an internal temperature within the battery module 100 exceeding a temperature threshold. For example, during the thermal event of the battery module 100, if the internal pressure within the battery module 100 exceeds the pressure threshold and/or the internal temperature within the battery module 100 exceeds the temperature threshold, the first flame retarding device 138 may rupture and release the flame retarding agent 141 to neutralize the gases ejected from one or more of the number of battery cells 118. In some examples, the first flame retarding device 138 may be designed so as to snap and open up due to increase in the internal pressure within the battery module 100, thereby releasing the flame retarding agent 141. In another example, the first flame retarding device 138 may be designed so as to melt due to increase in the internal temperature within the battery module 100, thereby releasing the flame retarding agent 141.

FIGS. 3A and 3B illustrate schematic views of exemplary first flame retarding devices 138. As illustrated in FIG. 3A, the first flame retarding device 138 includes an outer cover 137 that holds the flame retarding agent 141 therein. The outer cover 137 includes a circular shape herein.

As illustrated in FIG. 3B, the first flame retarding device 138 includes an outer cover 139 that holds the flame retarding agent 141 therein. The outer cover 139 includes a capsule shape herein. In other examples, the first flame retarding device 138 may have an outer cover of any shape or size, based on application attributes.

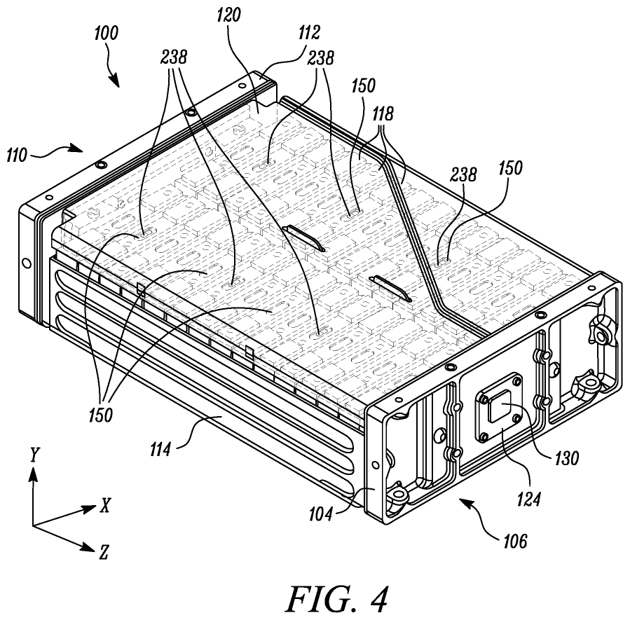

Referring to FIG. 4, a schematic perspective view of the battery module 100 is shown, according to an example of the present disclosure. The cover 122 (see FIG. 1) of the battery module 100 is not shown in FIG. 4 to illustrate components enclosed by the cover 122. As shown in FIG. 4, the battery module 100 further includes one or more second flame retarding devices 238 disposed within the battery module 100. The one or more second flame retarding devices 238 are same as the one or more first flame retarding devices 138. In other words, the second flame retarding device 238 is similar in design and functionality to the first flame retarding device 138 explained in relation to FIGS. 2, 3A, and 3B.

The battery cells 118 further includes a vent valve 150. The vent valve 150 may vent/release a pressure within the battery cell 118. In the illustrated example of FIG. 4, the one or more second flame retarding devices 238 is disposed proximate to the vent valve 150 of the battery cell 118 of the number of battery cells 118. Thus, the one or more second flame retarding devices 238 in a vent passage that extends from the battery cells 118 to the vent opening 108 (see FIG. 2). Specifically, the one or more second flame retarding devices 238 are coupled to the top plate 120 and faces the battery cell 118. Further, the one or more second flame retarding devices 238 is in alignment with the vent valve 150 of the battery cell 118. The one or more second flame retarding devices 238 includes multiple second flame retarding devices 238 coupled to a lower side of the top plate 120. In an example, the second flame retarding device 238 may be coupled to the top plate 120, for example, by an adhesive. The adhesive may include, for example, a double-sided adhesive tape or an adhesive layer. In other examples, the second flame retarding device 238 may be coupled to the top plate 120 via any other joining means known in the art.

FIG. 4 illustrates six second flame retarding devices 238 disposed proximate to the vent valve 150 of corresponding battery cells 118. It should be noted that a location of the second flame retarding devices 238 as shown herein is exemplary in nature, and the second flame retarding devices 238 may be disposed at any other location proximate to the vent valve 150.

Further, any number of second flame retarding devices 238 may be disposed proximate to the vent valve 150 of corresponding battery cells 118. For example, one or more second flame retarding devices 238 may be disposed proximate to the vent valve 150 of alternately disposed battery cells 118 or one or more second flame retarding devices 238 may be disposed proximate to the vent valve 150 of each battery cell 118.

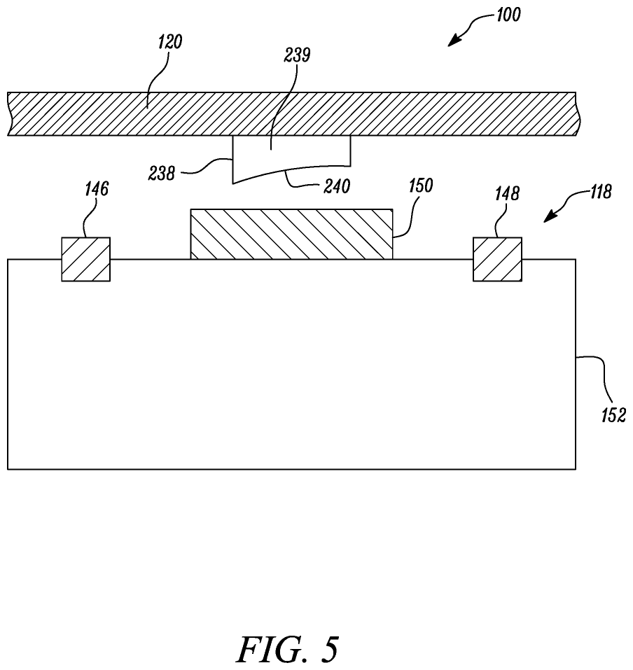

Referring to FIG. 5, a cross-sectional view of a single battery cell 118 associated with the battery module 100 of FIG. 1 is shown, according to an example of the present disclosure. Although only the single battery cell 118 is being explained, the details provided herein are equally applicable to other battery cells 118, without any limitations. A design of the battery cell 118 as illustrated herein is exemplary in nature.

Each battery cell 118 includes a positive terminal 146 and a negative terminal 148. Each battery cell 118 includes a container 152 containing an electrolyte (not shown). In some examples, the electrolyte may include a liquid electrolyte, a gel electrolyte, or a combination thereof. The positive terminal 146 and the negative terminal 148 are at least partially disposed within the container 152. The positive terminal 146, the negative terminal 148, and the electrolyte within the container 152 allow the battery cell 118 to generate electric power.

As shown in FIG. 5, the one or more second flame retarding devices 238 include a curved surface 240 facing the battery cell 118. Specifically, an outer cover 239 of the second flame retarding device 238 includes the curved surface 240. Specifically, the curved surface 240 faces the battery cell 118 and is in-line with the vent valve 150. The curved surface 240 of the second flame retarding device 238 may deflect/divert gases emitted from the battery cell 118 towards the vent opening 108 (see FIG. 2). In other words, the second flame retarding devices 238 may guide the gases released from one or more battery cells 118 towards the vent opening 108. It should be noted that each second flame retarding device 238 of the battery module 100 may include the curved surface 240 so as to deflect/divert the gases towards the vent opening 108.

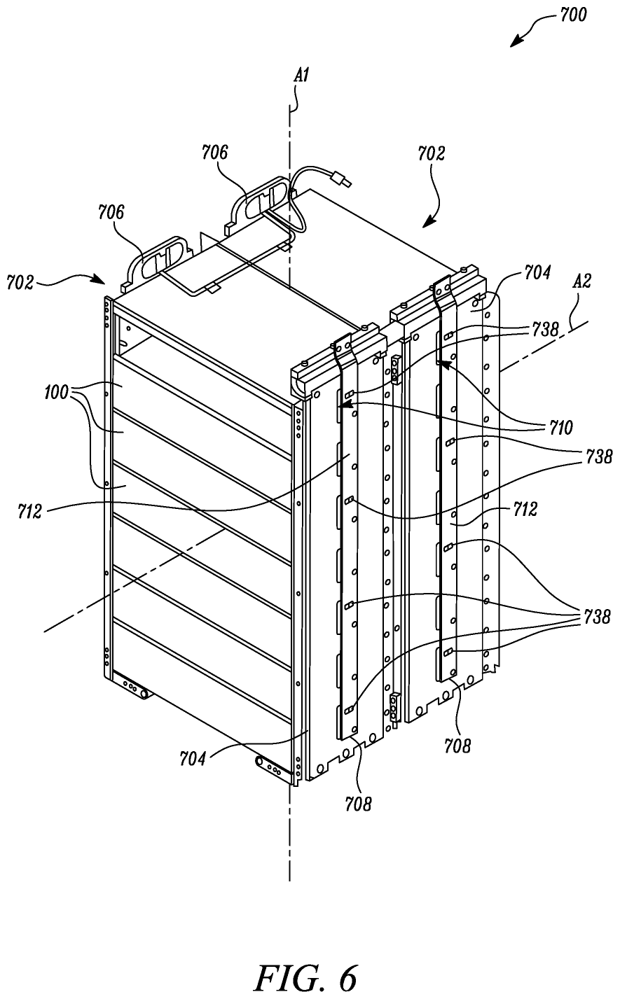

Referring to FIG. 6, a schematic perspective view of an exemplary battery system 700 is illustrated. The battery system 700 includes a pair of battery stacks 702. The battery stacks 702 include multiple battery modules 100 (such as the battery module 100 shown in FIGS. 1 to 5). The battery modules 100 are stacked along a vertical axis A1 of the battery system 700. The battery modules 100 are electrically coupled together in a stacked relationship to provide a desired amount of power output and voltage output. In the illustrated example of FIG. 6, the pair of battery stacks 702 are disposed adjacent to each other along a horizontal axis A2 that is perpendicular to the vertical axis A1. However, the battery system 700 may include any number of adjacently disposed battery stacks 702, based on application requirements.

Each battery stack 702 includes a first side member 704 and a second side member 706. Each of the first side member 704 and the second side member 706 are coupled to the number of battery modules 100. Each of the first side member 704 and the second side member 706 includes openings 710 that align with the vent opening 108 (see FIG. 2) in the first end plate 104 (see FIG. 1). Each of the first side member 704 and the second side member 706 are embodied as a rectangular plate herein. The battery system 700 further includes one or more plates 708 coupled to corresponding first and second side members 704, 706. The one or more plates 708 overlaps with corresponding first and second side members 704, 706 and may provide stability and rigidity to the battery system 700. The plates 708 coupled to the second side members 706 are obstructed from the view depicted in FIG. 6. It should be noted that the plates 708 are spaced apart from the first end plate 104 of the battery module 100 so as to allow removal of the pressure relief cap 130 (see FIG. 1), when the pressure relief cap 130 disengages from the base plate 124 (see FIG. 1).

The battery module 100 further includes one or more third flame retarding devices 738 coupled to an external surface 712 of the battery module 100. The one or more third flame retarding devices 738 are disposed proximate to the vent opening 108 of the first end plate 104. In the illustrated example of FIG. 6, the one or more third flame retarding devices 738 are disposed on the plates 708. Alternatively, the one or more third flame retarding devices 738 may be disposed on the first side members 704. Further, the one or more third flame retarding devices 738 are same as the one or more first flame retarding devices 138 shown explained in relation to FIGS. 2, 3A, and 3B. In the illustrated example of FIG. 6, four third flame retarding devices 738 are coupled to each plate 708, such that the battery system 700 includes eight third flame retarding devices 738 in total. However, the battery module 100 may include any number of third flame retarding devices 738 based on application attributes.

In other examples, the third flame retarding devices 738 may be coupled to a side surface of the cover 122 (see FIG. 1) or a top surface of the cover 122 of the top battery modules 100, such that the third flame retarding devices 738 are proximate to the vent openings 108 of corresponding battery modules 100.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is directed towards the first, second, and third flame retarding devices 138, 238, 738 that may prevent damage to one or more components of the battery module 100 or disposed around the battery module 100, in the case of thermal events of one or more battery cells 118. The first, second, and third flame retarding devices 138, 238, 738 neutralize the gases ejected from one or more of the number of battery cells 118 during the thermal event of one or more battery cells 118. Each of the first, second, and third flame retarding devices 138, 238, 738 ruptures based on the internal pressure within the battery module 100 exceeding the pressure threshold and/or the internal temperature within the battery module 100 exceeding the temperature threshold, thereby releasing the flame retarding agent 141.

During thermal events, one or more of the battery cells 118 may generate extreme amounts of heat and gases. As the internal pressure exceeds the pressure threshold and/or the internal temperature exceeds the temperature threshold, the first, second, and third flame retarding devices 138, 238, 738 may rupture and release the flame retarding agent 141 that may enable the battery module 100 to depressurize. The release of the flame retarding agent 141 may prevent failure of the battery module 100 itself and may also prevent damage to components located around the battery module 100.

The flame retarding agent 141 released from the flame retarding devices 138, 238, 738 may block initial entry of oxygen into the battery module 100 and/or the battery cells 118 thereby preventing reaction of the gases ejected from the battery cells 118 with the oxygen during the thermal event. Further, each of the first, second, and third flame retarding devices 138, 238, 738 may block further endothermic reactions with oxygen and may prevent thermal runaway propagation within the battery module 100 and thus may prevent a release of gases into the environment.

Thus, the first flame retarding device 138 that is disposed within the battery module 100, proximate to the vent opening 108, may dilute the gases released from the battery cells 118, thereby preventing combustion within the battery module 100. Further, the filter membrane 136 may capture any particles released from the battery cells 118, thereby preventing release of such particles into the environment. Furthermore, the third flame retarding devices 738 disposed outside the battery module 100 provides a means to contain combustion once the gases released from the battery cells 118 exit the battery module 100. Moreover, the second flame retarding devices 238 include the curved surface 240 that may divert and guide gases released from one or more battery cells 118 towards the vent opening 108.

The first, second, and third flame retarding devices 138, 238, 738 described herein are simple in construction and cost-effective. Further, the first, second, and third flame retarding devices 138, 238, 738 may be coupled to the battery module 100 in a time efficient manner without requiring costly set-ups or high operator expertise.

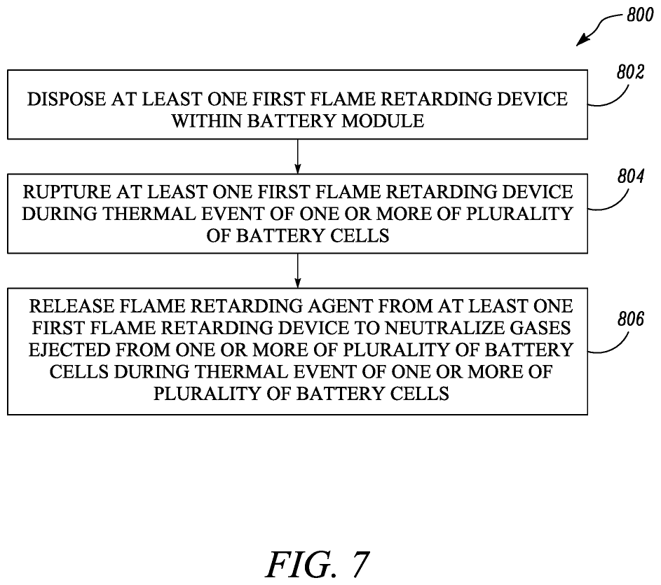

FIG. 7 is a flowchart for a method 800 of neutralizing gases ejected from the battery module 100 of FIG. 1. With reference to FIGS. 1 to 7, at step 802, the one or more first flame retarding devices 138 are disposed within the battery module 100. The one or more first flame retarding devices 138 hold the flame retarding agent 141 therein. The flame retarding agent 141 includes the halogen agent, the carbonate agent, the polyolefin agent, and/or a combination thereof. The battery module 100 includes the housing 102 including the first end plate 104 defining the vent opening 108, the second end plate 112, the first side plate 114 coupled to the first end plate 104 and the second end plate 112, and the second side plate 116 coupled to the first end plate 104 and the second end plate 112. The battery module 100 includes the number of battery cells 118 secured within the housing 102 between the first end plate 104, the second end plate 112, the first side plate 114, and the second side plate 116. The one or more first flame retarding devices 138 are coupled to the housing 102 proximate to the vent opening 108 of the first end plate 104.

At step 804, the one or more first flame retarding devices 138 rupture during the thermal event of one or more of the number of battery cells 118. The one or more first flame retarding devices 138 rupture based on the internal pressure within the battery module 100 exceeding the pressure threshold and/or the internal temperature within the battery module 100 exceeding the temperature threshold.

At step 806, the flame retarding agent 141 releases from the one or more first flame retarding devices 138 to neutralize gases ejected from one or more of the number of battery cells 118 during the thermal event of one or more of the number of battery cells 118.

The first end plate 104 further includes the base plate 124. The base plate 124 defines the first side 126 and the second side 128 opposite the first side 126. The battery module 100 further includes the pressure relief cap 130 coupled to the base plate 124 at the first side 126 of the base plate 124.

The housing 102 further includes the filter assembly 132 coupled to the base plate 124 at the second side 128 of the base plate 124. The filter assembly 132 includes the mesh screen 134 and the filter membrane 136. The filter membrane 136 is disposed between the mesh screen 134 and the base plate 124. The step 802 of disposing the one or more first flame retarding devices 138 further includes coupling the one or more first flame retarding devices 138 to the filter membrane 136.

The method 800 includes a step at which the one or more second flame retarding devices 238 are disposed within the battery module 100. The one or more second flame retarding devices 238 are same as the one or more first flame retarding devices 138. The one or more second flame retarding devices 238 hold the flame retarding agent 141 therein. The method 800 also includes a step at which the one or more second flame retarding devices 238 rupture during the thermal event of one or more of the number of battery cells 118. The method 800 further includes a step at which the flame retarding agent 141 releases from the one or more second flame retarding devices 238 to neutralize gases ejected from one or more of the number of battery cells 118 during the thermal event of one or more of the number of battery cells 118.

Furthermore, the step of disposing the one or more second flame retarding devices 238 include disposing the one or more second flame retarding devices 238 proximate to the vent valve 150 of the battery cell 118 of the number of battery cells 118.

The battery module 100 further includes the top plate 120 covering at least the portion of the number of battery cells 118. The step of disposing the one or more second flame retarding devices 238 further includes coupling the one or more second flame retarding device 238 to the top plate 120, such that the one or more second flame retarding devices 238 face the battery cell 118. Further, the one or more second flame retarding devices 238 are in alignment with the vent valve 150 of the battery cell 118. Furthermore, the one or more second flame retarding devices 238 include the curved surface 240 facing the battery cell 118.

Moreover, the method 800 includes coupling the one or more third flame retarding device 738 to the external surface 712 of the battery module 100. The one or more third flame retarding devices 738 are disposed proximate to the vent opening 108 of the first end plate 104. The one or more third flame retarding devices 738 are same as the one or more first flame retarding devices 138. The one or more third flame retarding devices 738 hold the flame retarding agent 141 therein. The method 800 also includes a step at which the one or more third flame retarding devices 738 rupture during the thermal event of one or more of the number of battery cells 118. The method 800 further includes releasing the flame retarding agent 141 from the one or more third flame retarding devices 738 to neutralize gases ejected from one or more of the number of battery cells 118 during the thermal event of one or more of the number of battery cells 118.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A battery module comprising:
a housing including:
a first end plate defining a first end of the battery module, the first end plate defining a vent opening;
a second end plate defining a second end of the battery module opposite the first end;
a first side plate coupled to the first end plate and the second end plate; and
a second side plate opposite the first side plate, the second side plate being coupled to the first end plate and the second end plate;
a plurality of battery cells secured within the housing between the first end plate, the second end plate, the first side plate, and the second side plate; and
at least one first flame retarding device disposed within the battery module, wherein the at least one first flame retarding device is coupled to the housing proximate to the vent opening of the first end plate, wherein the at least one first flame retarding device holds a flame retarding agent therein, and wherein the at least one first flame retarding device ruptures and releases the flame retarding agent to neutralize gases ejected from one or more of the plurality of battery cells during a thermal event of one or more of the plurality of battery cells.

2. The battery module of claim 1, wherein the at least one first flame retarding device ruptures based on at least one of an internal pressure within the battery module exceeding a pressure threshold and an internal temperature within the battery module exceeding a temperature threshold.

3. The battery module of claim 1, wherein the first end plate further includes:
a base plate defining a first side and a second side opposite the first side; and
a pressure relief cap coupled to the base plate at the first side of the base plate.

4. The battery module of claim 3, wherein the housing further includes a filter assembly coupled to the base plate at the second side of the base plate, the filter assembly including a mesh screen and a filter membrane, wherein the filter membrane is disposed between the mesh screen and the base plate, and wherein the at least one first flame retarding device is coupled to the filter membrane.

5. The battery module of claim 1, wherein the flame retarding agent includes at least one of a halogen agent, a carbonate agent, a polyolefin agent, and a combination thereof.

6. The battery module of claim 1, further comprising at least one second flame retarding device disposed within the battery module, wherein the at least one second flame retarding device is same as the at least one first flame retarding device.

7. The battery module of claim 6, wherein the at least one second flame retarding device is disposed proximate to a vent valve of a battery cell of the plurality of battery cells.

8. The battery module of claim 7, further comprising a top plate covering at least a portion of the plurality of battery cells, wherein the at least one second flame retarding device is coupled to the top plate and faces the battery cell, and wherein the at least one second flame retarding device is in alignment with the vent valve of the battery cell.

9. The battery module of claim 8, wherein the at least one second flame retarding device includes a curved surface facing the battery cell.

10. The battery module of claim 1, further comprising at least one third flame retarding device coupled to an external surface of the battery module, wherein the at least one third flame retarding device is disposed proximate to the vent opening of the first end plate, and wherein the at least one third flame retarding device is same as the at least one first flame retarding device.

11. A method of neutralizing gases ejected from a battery module, the method comprising:
disposing at least one first flame retarding device within the battery module, wherein the at least one first flame retarding device holds a flame retarding agent therein, wherein the battery module includes a housing including a first end plate defining a vent opening, a second end plate, a first side plate coupled to the first end plate and the second end plate, and a second side plate coupled to the first end plate and the second end plate, wherein the battery module includes a plurality of battery cells secured within the housing between the first end plate, the second end plate, the first side plate, and the second side plate, and wherein the at least one first flame retarding device is coupled to the housing proximate to the vent opening of the first end plate;
rupturing the at least one first flame retarding device during a thermal event of one or more of the plurality of battery cells; and
releasing the flame retarding agent from the at least one first flame retarding device to neutralize gases ejected from one or more of the plurality of battery cells during the thermal event of one or more of the plurality of battery cells.

12. The method of claim 11, wherein the at least one first flame retarding device ruptures based on at least one of an internal pressure within the battery module exceeding a pressure threshold and an internal temperature within the battery module exceeding a temperature threshold.

13. The method of claim 11, wherein the first end plate further includes:
a base plate defining a first side and a second side opposite the first side; and
a pressure relief cap coupled to the base plate at the first side of the base plate.

14. The method of claim 13, wherein the housing further includes a filter assembly coupled to the base plate at the second side of the base plate, the filter assembly including a mesh screen and a filter membrane, wherein the filter membrane is disposed between the mesh screen and the base plate, and wherein the step of disposing the at least one first flame retarding device further includes coupling the at least one first flame retarding device to the filter membrane.

15. The method of claim 11, wherein the flame retarding agent includes at least one of a halogen agent, a carbonate agent, a polyolefin agent, and a combination thereof.

16. The method of claim 11, further comprising:
disposing at least one second flame retarding device within the battery module, wherein the at least one second flame retarding device is same as the at least one first flame retarding device, and wherein the at least one second flame retarding device holds a flame retarding agent therein;
rupturing the at least one second flame retarding device during the thermal event of one or more of the plurality of battery cells; and
releasing the flame retarding agent from the at least one second flame retarding device to neutralize gases ejected from one or more of the plurality of battery cells during the thermal event of one or more of the plurality of battery cells.

17. The method of claim 16, wherein the step of disposing the at least one second flame retarding device further includes disposing the at least one second flame retarding device proximate to a vent valve of a battery cell of the plurality of battery cells.

18. The method of claim 17, wherein the battery module further includes a top plate covering at least a portion of the plurality of battery cells, wherein the step of disposing the at least one second flame retarding device further includes coupling the at least one second flame retarding device to the top plate, such that the at least one second flame retarding device faces the battery cell, and wherein the at least one second flame retarding device is in alignment with the vent valve of the battery cell.

19. The method of claim 18, wherein the at least one second flame retarding device includes a curved surface facing the battery cell.

20. The method of claim 11, further comprising:
coupling at least one third flame retarding device to an external surface of the battery module, wherein the at least one third flame retarding device is disposed proximate to the vent opening of the first end plate, wherein the at least one third flame retarding device is same as the at least one first flame retarding device, and wherein the at least one third flame retarding device holds a flame retarding agent therein;
rupturing the at least one third flame retarding device during the thermal event of one or more of the plurality of battery cells; and
releasing the flame retarding agent from the at least one third flame retarding device to neutralize gases ejected from one or more of the plurality of battery cells during the thermal event of one or more of the plurality of battery cells.
